(19) United States
(12) Patent Application Publication
(10) Pub. No.: US 2007/0197190 A1
(43) Pub. Date: Aug. 23, 2007

(54) ACCESS POINT AND METHOD FOR IDENTIFYING COMMUNICABLE STATUSES FOR THE SAME

(75) Inventor: CHENG-WEN TANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,184

(22) Filed: Nov. 3, 2006

(30) Foreign Application Priority Data
Feb. 17, 2006 (CN) 200610033805.1

(51) Int. Cl. H04M 3/16

(52) U.S. Cl. 455/410

(57) ABSTRACT

An access point (100), for determining whether the access point and a plurality of other access points within the scope of the access point support the same pre-shared key (PSK), includes a dummy module (110) and a dummy mobile station (120). The dummy mobile station is produced by the dummy module, and includes an authentication submodule (121), an association submodule (122), and a handshake submodule (123). The authentication submodule authenticates the plurality of other access points. The association submodule associates with the plurality of other access points. The handshake submodule runs 4-way handshakes with the plurality of other access points, and determines whether any of the plurality of other access points and the access point support the same PSK. A method for identifying PSKs thereof is also provided.

### BACKGROUND OF THE INVENTION

1. Field of the Invention

The invention relates to wireless communications, and particularly to an access point and a method for identifying communicable statuses.

2. Description of Related Art

In a wireless communication system, if a mobile station employs a pre-shared key (PSK) connection, an access point communicating with the mobile station must support the same PSK connection. The same PSK connection indicates that the mobile station and the access point both employ the PSK connection, and support the same PSK. Therefore, the mobile station employing the PSK must find an access point supporting the same PSK, when the mobile station needs to roam between networks.

In a conventional method, when a mobile station needs to roam between networks, the mobile station disconnects with a current access point (namely an access point currently communicating with the mobile station). Then the mobile station scans new access points in another network. If the mobile station finds that a new access point and the mobile station support different PSKs during connection, the mobile station keeps trying to connect to other new access points one by one to find an access point supporting the same PSK, which is time-consuming. Thus, the conventional method wastes time of the mobile station.

### SUMMARY OF THE INVENTION

An exemplary embodiment of the present invention provides an access point that determines whether the access point and a plurality of other access points within the scope of the access point support the same pre-shared key (PSK). The access point includes a dummy module and a dummy mobile station. The dummy mobile station is produced by the dummy module, and includes an authentication submodule, an association submodule, and a handshake submodule. The authentication submodule authenticates the plurality of other access points. The association submodule associates with the plurality of other access points. The handshake submodule runs 4-way handshakes with the plurality of other access points, and determines whether the plurality of other access points and the access point support the same PSK.

Another exemplary embodiment of the present invention provides a method for identifying communicable statuses. The method includes providing a first access point and a plurality of second access points, wherein the plurality of second access points are within the scope of the first access point; producing a dummy mobile station by the first access point; authenticating one of the second access points by the dummy mobile station; associating with the second access point by the dummy mobile station; running a 4-way handshake with the second access point by the dummy mobile station; determining whether the 4-way handshake is successful; and determining that the dummy mobile station and the second access point support the same PSK if the 4-way handshake is successful.

Other advantages and novel features will become more apparent from the following detailed description when taken in conjunction with the accompanying drawings, in which:

### BRIEF DESCRIPTION OF THE DRAWINGS

FIG. 1 is a schematic diagram of a wireless communication system of an exemplary embodiment of the present invention;

FIG. 2 is a schematic block diagram of functional modules of an access point of another exemplary embodiment of the present invention;

FIG. 3 is a schematic block diagram of functional modules of an access point of a further exemplary embodiment of the present invention;

FIG. 4 is a flowchart of a method for identifying communicable statuses of a still further exemplary embodiment of the present invention;

FIG. 5 is a flowchart of a method for identifying communicable statuses of a yet further exemplary embodiment of the present invention; and

FIG. 6 is a detailed flowchart of the method for identifying communicable statuses of FIG. 4.

### DETAILED DESCRIPTION OF THE INVENTION

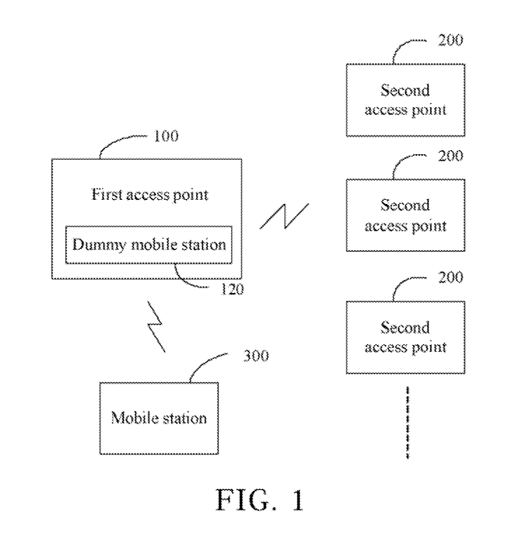

FIG. 1 is a schematic diagram of a wireless communication system of an exemplary embodiment of the present invention. In the exemplary embodiment, the wireless communication system includes a first access point 100, a plurality of second access points 200, and a mobile station 300. The first access point 100 includes a dummy mobile station 120 initially produced by the first access point 100. The mobile station 300 may be a notebook computer, a personal digital assistant (PDA), or another mobile electrical device.

The mobile station 300 initially communicates with the first access point 100, and the mobile station 300 and the first access point 100 support the same pre-shared key (PSK). The mobile station 300 can roam from the first access point 100 to one of the plurality of second access points 200, which are within the scope of the first access point 100. In the exemplary embodiment, the first access point 100 authenticates, associates with, and runs a 4-way handshake with each of the second access point 200 via the dummy mobile station 120, and accordingly determines whether the second access point 200 and the first access point 100 support the same PSK, namely whether the second access point 200 and the mobile station 300 support the same PSK. Then the first access point 100 transmits the PSKs of the second access points 200 to the mobile station 300. When receiving the PSKs of the second access points 200, the mobile station 300 can select one of the second access points 200 supporting the same PSK to communicate with. Therefore, roaming time of the mobile station 300 is effectively reduced.

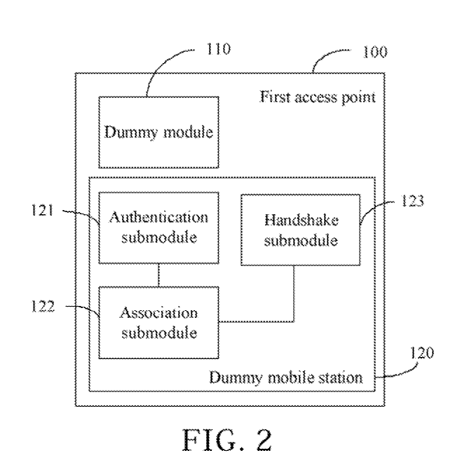

FIG. 2 is a schematic block diagram of functional modules of the first access point 100 of an exemplary embodiment of the present invention. In the exemplary embodiment, the first access point 100 includes a dummy module 110 and the dummy mobile station 120. The dummy module 110 produces the dummy mobile station 120. In the exemplary embodiment, the dummy module 110 produces a dummy media access control (MAC) address to represent the dummy mobile station 120. When the first access point 100 transmits frames to the second access points 200 by the dummy MAC address, the first access point 100 is regarded as a new mobile station, namely the dummy mobile station 120. The dummy mobile station 120 includes an authentication submodule 121, an association submodule 122, and a handshake submodule 123.

The authentication submodule 121 authenticates the plurality of second access points 200. In the exemplary embodiment, the authentication submodule 121 transmits an authentication request frame to one of the second access points 200, and then receives an authentication response frame from the second access point 200. Therefore, authentication between the dummy mobile station 120 and the second access point 200 is completed.

The association submodule 122 associates with the plurality of second access points 200. In the exemplary embodiment, after the authentication submodule 121 authenticates the second access points 200, the association submodule 122 transmits an association request frame to one of the second access points 200, and then receives an association response frame from the second access point 200. Therefore, association between the dummy mobile station 120 and the second access point 200 is completed.

The handshake submodule 123 runs 4-way handshakes with the plurality of second access points 200, and determines whether the plurality of second access points 200 and the dummy mobile station 120 support the same PSK, namely whether the plurality of second access points 200 and the first access point 100 support the same PSK. In the exemplary embodiment, after the association submodule 122 associates with the second access points 200, the handshake submodule 123 runs a 4-way handshake with one of the second access points 200.

The 4-way handshake between the dummy mobile station 120 and the second access point 200 includes the following 4 steps. In the first step, the second access point 200 transmits a first extensive authentication protocol over local area network key (EAPOL-Key) frame to the handshake submodule 123. The first EAPOL-Key frame includes an authenticator nonce (ANonce). In the second step, the handshake submodule 123 transmits a second EAPOL-Key frame to the second access point 200. The second EAPOL-Key frame includes a supplicant nonce (SNonce). In the third step, the second access point 200 transmits a third EAPOL-Key frame to the handshake submodule 123. The third EAPOL-Key frame includes a message integrity code (MIC) value of the second access point 200. The MIC value of the second access point 200 is calculated by the second access point 200 according to the ANonce, the Snonce, and a key of the second access point 200.

If the 4-way handshake is successful, in the fourth step, the handshake submodule 123 transmits a fourth EAPOL-Key frame to the second access point 200 to indicate that the 4-way handshake is successful. If the 4-way handshake is not successful, the handshake submodule 123 transmits a disassociation frame to the second access point 200 or does not respond. Therefore, the 4-way handshake is ended.

The handshake submodule 123 can determine whether the 4-way handshake is successful after the third step of the 4-way handshake. In the exemplary embodiment, the handshake submodule 123 calculates an MIC value of the dummy mobile station 120 according to the ANonce, the SNonce, and a key of the dummy mobile station 120, and determines whether the MIC value of the second access point 200 is the same as the MIC value of the dummy mobile station 120. If the MIC value of the second access point 200 is the same as the MIC value of the dummy mobile station 120, the 4-way handshake is successful. That is, the dummy mobile station 120 and the second access point 200 support the same PSK. Then, in the fourth step of the 4-way handshake, the handshake submodule 123 transmits a fourth EAPOL-Key frame to the second access point 120.

On the contrary, if the MIC value of the second access point 200 is not the same as the MIC value of the dummy mobile station 120, the 4-way handshake is not successful. That is, the dummy mobile station 120 and the second access point 200 support different PSKs. Then, in the fourth step of the 4-way handshake, the handshake submodule 123 transmits a disassociation frame to the second access point 200, or does not respond.

In another exemplary embodiment, the first access point 100 may further transmit an add traffic spec (ADDTS) request frame to the plurality of the second access points 200 by the dummy mobile station 120, and acquires admission control (AC) parameter states of the plurality of second access points 200. The AC parameter includes a best effort (BE) parameter, a background (BK) parameter, a video (VI) parameter, and a voice (VO) parameter. In the exemplary embodiment, the AC parameter states indicate whether the plurality of second access points 200 accept mobile stations employing VO parameters. Then the first access point 100 transmits the AC parameter states of the plurality of second access points 200 to the mobile station 300. After receiving the AC parameter states of the plurality of second access points 200, the mobile station 300 can select one of the second access points 200 accepting a mobile station employing the VO parameter to communicate with, if the mobile station 300 needs to transmit data by employing the VO parameter. Therefore, roaming time of the mobile station 300 is further reduced.

In the exemplary embodiment, each of the second access points 200 limits an amount of the mobile stations employing the VO parameters. For example, each of the second access points 200 limits an amount of mobile stations employing voice over Internet protocol (VoIP), in order to assure quality of the VoIP service. Therefore, when the amount of mobile stations supported by the second access point 200 reaches a predetermined amount, such as 8 mobile stations, then the second access point 20 does not accept other mobile stations employing the VO parameters.

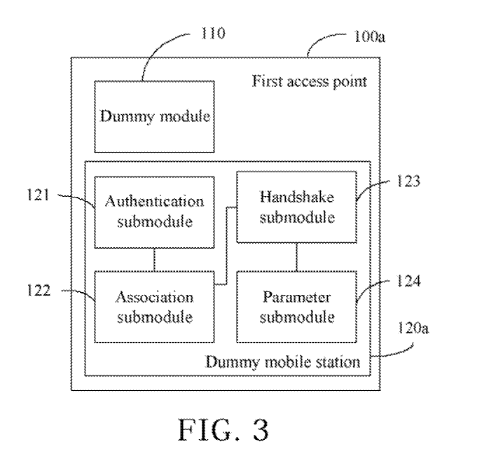

FIG. 3 is a schematic block diagram of functional modules of a first access point 100a of another exemplary embodiment of the present invention. The difference between the first access point 100a and the first access point 100 is that a dummy mobile station 120a of the first access point 100a further includes a parameter submodule 124. The parameter submodule 124 determines AC parameter states of the plurality of second access points 200. Other modules of this embodiment are the same as those of FIG. 2, so descriptions are omitted.

In the exemplary embodiment, after the handshake submodule 123 runs the 4-way handshakes with the second access points 200, the parameter submodule 124 transmits an ADDTS request frame to one of the second access points 200 to transmit data by employing the VO parameter. Then the parameter submodule 124 receives an ADDTS response frame from the second access point 200. The ADDTS response frame includes a state code for indicating whether the second access point 200 accepts the ADDTS request frame, namely indicating whether the second access point 200 accepts a mobile station employing the VO parameter. If the state code is 0, the second access point 200 accepts the ADDTS request frame. If the state code is not 0, the second access point 200 does not accept the ADDTS request frame.

After receiving the ADDTS response frame, the parameter submodule 124 determines the AC parameter state of the access point 200 according to the state code of the ADDTS response frame. If the state code is 0, the parameter submodule 124 determines that the second access point 200 accepts a mobile station employing the VO parameter. If the state code is not 0, the parameter submodule 124 determines that the second access point 200 does not accept a mobile station employing the VO parameter.

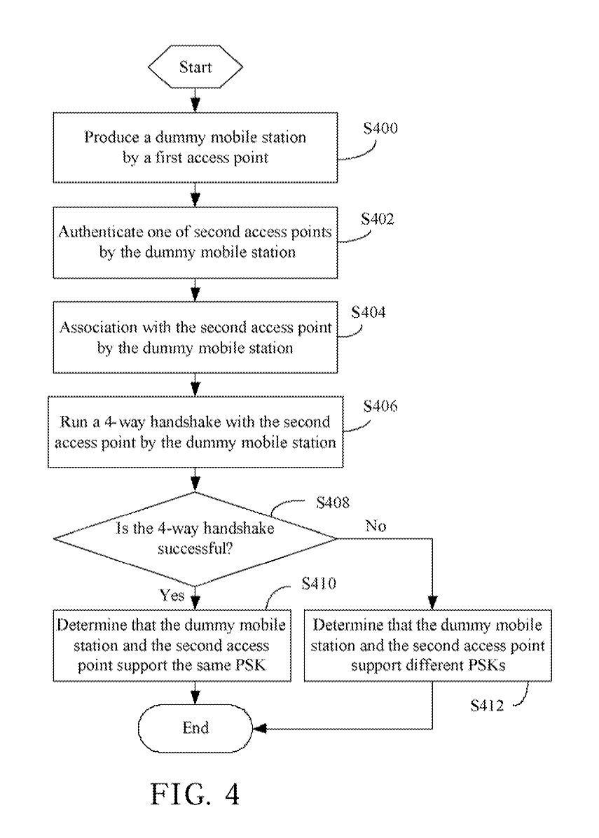

FIG. 4 is a flowchart of a method for identifying communicable statuses of an exemplary embodiment of the present invention. In the exemplary embodiment, the first access point 100 needs to identify whether each of the second access points 200 and the first access point 100 support the same PSK.

In step S400, the first access point 100 produces the dummy mobile station 120.

In step S402, the dummy mobile station 120 authenticates one of the second access points 200.

In step S404, the dummy mobile station 120 associates with the second access point 200.

In step S406, the dummy mobile station 120 runs a 4-way handshake with the second access point 200.

In step S408, the dummy mobile station 120 determines whether the 4-way handshake is successful.

If the 4-way handshake is successful, in step S410, the dummy mobile station 120 determines that the dummy mobile station 120 and the second access point 200 support the same PSK. That is, the second access point 200 and the first access point 100 support the same PSK.

If the 4-way handshake is not successful, in step S412, the dummy mobile station 120 determines that the dummy mobile station 120 and the second access point 200 support different PSKs. That is, the second access point 200 and the first access point 100 support different PSKs.

In the exemplary embodiment, the first access point 100 identifies the second access points 200 and the first access point 100 that support the same PSK one by one. For example, the first access point 100 authenticates, associates with, and runs the 4-way handshake with one of the second access points 200 via the dummy mobile station 120, and then authenticates, associates with, and runs the 4-way handshake with another of the second access points 200 via the dummy mobile station 120. The first access point 100 therefore records all identified results about all second access points 200 in order to provide to its associated mobile stations before they roaming to any of the second access points 200.

In another embodiment, the first access point 100 may identify the second access points 200 and the first access point 100 that support the same PSK simultaneously. That is, the first access point 100 authenticates, associates with, and runs the 4-way handshake with the plurality of second access points 200 simultaneously via the dummy mobile station 120.

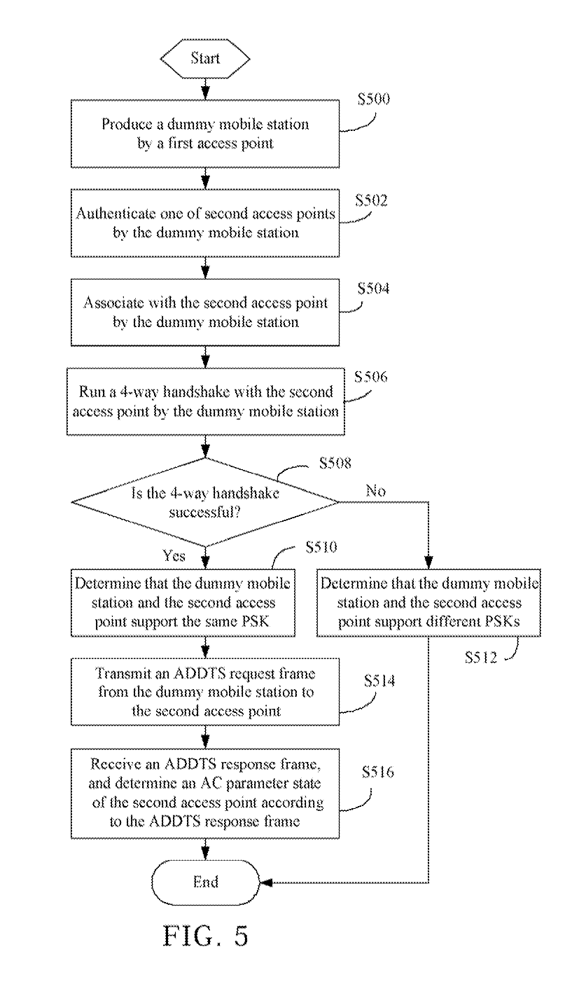

FIG. 5 is a flowchart of a method for identifying communicable statuses of another exemplary embodiment of the present invention. The steps S500, S502, S504, S506, S508, S510, and S512 of this embodiment are the same as steps S400, S402, S404, S406, S408, S410, and S412 of FIG. 4. The difference is that, in step S514, the dummy mobile station 120 further transmits an ADDTS request frame to the second access point 200 to transmit data by employing a VO parameter.

The second access point 200 receives the ADDTS request frame, and then sends back an ADDTS response frame to the dummy mobile station 120. The ADDTS response frame includes a state code for indicating whether the second access point 200 accepts the ADDTS request frame, namely indicating whether the second access point 200 accepts a mobile station employing the VO parameter.

In step S516, the dummy mobile station 120 receives the ADDTS response frame from the second access point 200, and determines an AC parameter state of the second access point 200 according to the ADDTS response frame. In the exemplary embodiment, the AC parameter state indicates whether the second access point 200 accepts a mobile station employing the VO parameter. The dummy mobile station 120 determines the AC parameter state of the second access point 200 according to the state code of the ADDTS response frame.

If the state code is 0, the dummy mobile station 120 determines that the second access point 200 accepts the ADDTS request frame. That is, the second access point 200 accepts a mobile station employing the VO parameter. If the state code is not 0, the dummy mobile station 120 determines that the second access point 200 does not accept the ADDTS request frame. That is, the second access point 200 does not accept a mobile station employing the VO parameter.

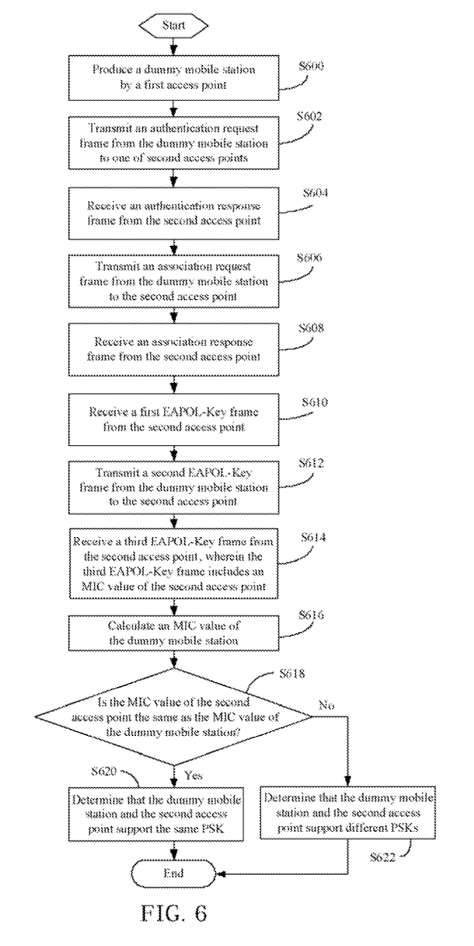

FIG. 6 is a detailed flowchart of the method for identifying communicable statuses of FIG. 4.

In step S600, the first access point 100 produces the dummy mobile station 120. In the exemplary embodiment, the first access point 100 produces a dummy MAC address to represent the dummy mobile station 120. When the first access point 100 transmits frames to the second access point 200 by the dummy MAC address, the first access point 100 is regarded as a new mobile station, namely the dummy mobile station 120.

In step S602, the dummy mobile station 120 transmits an authentication request frame to one of the second access points 200. In the exemplary embodiment, the second access point 200 receives the authentication request frame from the dummy mobile station 120, and then sends back an authentication response frame.

In step S604, the dummy mobile station 120 receives the authentication response frame from the second access point 200. Therefore, authentication between the dummy mobile station 120 and the second access point 200 is completed.

In step S606, the dummy mobile station 120 transmits an association request frame to the second access point 200. In the exemplary, the access point 200 receives the association request frame from the dummy mobile station 120, and then sends back an association response frame.

In step S608, the dummy mobile station 120 receives the association response frame from the second access point 200. Therefore, association between the dummy mobile station 120 and the second access point 200 is completed.

In step S610, the dummy mobile station 120 receives a first EAPOL-Key frame from the second access point 200. The first EAPOL-Key frame includes an ANonce.

In step S612, the dummy mobile station 120 transmits a second EAPOL-Key frame to the second access point 200. The second EAPOL-Key frame includes a SNonce.

In step S614, the dummy mobile station 120 receives a third EAPOL-Key frame from the second access point 200. The third EAPOL-Key frame includes an MIC value of the second access point 200. The MIC value of the second access point 200 is calculated by the second access point 200 according to the ANonce, the Snonce, and a key of the second access point 200.

In step S616, the dummy mobile station 120 calculates a MIC value thereof according to the ANonce, the SNonce, and a key of the dummy mobile station 120.

In step S618, the dummy mobile station 120 determines whether the MIC value of the second access point 200 is the same as the MIC value of the dummy mobile station 120.

If the MIC value of the second access point 200 is the same as the MIC value of the dummy mobile station 120, the 4-way handshake is successful. Accordingly, in step S620, the dummy mobile station 120 determines that the dummy mobile station 120 and the second access point 200 support the same PSK.

If the MIC value of the second access point 200 is not the same as the MIC value of the dummy mobile station 120, the 4-way handshake is not successful. Accordingly, in step S622, the dummy mobile station 120 determines that the dummy mobile station 120 and the second access point 200 support different PSKs.

In the exemplary embodiment, if the 4-way handshake is successful, the dummy mobile station 120 transmits a fourth EAPOL-Key frame to the second access point 200. If the 4-way handshake is not successful, the dummy mobile station 120 transmits a disassociation frame to the second access point 200, or does not respond.

In the exemplary embodiment of the present invention, the first access point 100 can determine whether the first access point 100 and the plurality of second access points 200 within the scope of the first access point 100 support the same PSK in advance. Then the first access point 100 informs the mobile station 300 of PSK states of the plurality of second access points 200 via an information element (IE) of a beacon frame, or an MAC protocol data unit (MPDU) predefined by the first access point 100 and the mobile station 300. Knowing the PSK states of the plurality of second access points 200, the mobile station 300 can select one of the second access points 200 supporting the same PSK to communicate with. Therefore, roaming time of the mobile station 300 is effectively reduced.

In addition, the first access point 100 can further determine AC parameter states of the plurality of second access points 200. Then the first access point 100 informs the mobile station 300 of the AC parameter states of the plurality of second access points 200 via an IE of a beacon frame, or an MPDU predefined by the first access point 100 and the mobile station 300. Knowing the AC parameter states of the plurality of second access points 200, the mobile station 300 can select one of the second access points 200 accepting a mobile station employing the VO parameter to communicate with, if the mobile station 300 needs to transmit data by employing the VO parameter. Therefore, roaming time of the mobile station 300 is further reduced.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An access point, for identifying whether the access point and a plurality of other access points within the scope of the access point support the same pre-shared key (PSK), comprising:
a dummy module; and
a dummy mobile station, produced by the dummy module, comprising:
an authentication submodule, for authenticating the plurality of other access points;
an association submodule, for associating with the plurality of other access points; and
a handshake submodule, for running 4-way handshakes with the plurality of other access points, and determining whether the plurality of other access points and the access point support the same PSK.

2. The access point as claimed in claim 1, wherein the dummy mobile station further comprises a parameter submodule, for identifying access control (AC) parameter states of the plurality of other access points.

3. The access point as claimed in claim 2, wherein the AC parameter states of the plurality of other access points indicate whether the plurality of other access points accept mobile stations using voice parameters.

4. A method for identifying communicable statuses comprising:
providing a first access point and a plurality of second access points, wherein the plurality of second access points are within the scope of the first access point;
producing a dummy mobile station by the first access point;
authenticating one of the second access points by the dummy mobile station;
associating with the second access point by the dummy mobile station;
running a 4-way handshake with the second access point by the dummy mobile station;
determining whether the 4-way handshake is successful; and
determining that the dummy mobile station and the second access point support the same pre-shared key (PSK) if the 4-way handshake is successful.

5. The method as claimed in claim 4, further comprising:
determining that the dummy mobile station and the second access point support different PSKs if the 4-way handshake is not successful.

6. The method as claimed in claim 4, further comprising:
transmitting an add traffic spec (ADDTS) request frame from the dummy mobile station to the second access point; and
receiving an ADDTS response frame from the second access point, and determining an access control (AC) parameter state of the second access point according to the ADDTS response frame.

7. The method as claimed in claim 6, wherein the AC parameter state of the second access point indicates whether the second access point accepts a mobile station using a voice parameter.

8. The method as claimed in claim 4, wherein the producing step comprises:
producing a dummy media access control (MAC) address to represent the dummy mobile station.

9. The method as claimed in claim 4, wherein the authenticating step comprises:
transmitting an authentication request frame from the dummy mobile station to the second access point; and
receiving an authentication response frame from the second access point.

10. The method as claimed in claim 4, wherein the associating step comprises:
transmitting an association request frame from the dummy mobile station to the second access point; and
receiving an association response frame from the second access point.

11. The method as claimed in claim 4, wherein the running step comprises:
receiving a first extensive authentication protocol over local area network key (EAPOL-Key) frame from the second access point, wherein the first EAPOL-Key comprises an authenticator nonce (Anonce);
transmitting a second EAPOL-Key frame from the dummy mobile station to the second access point, wherein the second EAPOL-Key comprises a supplicant nonce (Snonce); and
receiving a third EAPOL-Key from the second access point, wherein the third EAPOL-Key comprises a message integrity code (MIC) of the second access point calculated by the second access point according to the Anonce, the Snonce and a key of the second access point.

12. The method as claimed in claim 11, wherein the step of determining whether the 4-way handshake is successful comprises:
calculating an MIC of the dummy mobile station according to the Anonce, the Snonce, and a key of the dummy mobile station;
determining whether the MIC of the second access point is the same as the MIC of the dummy mobile station; and
determining that the 4-way handshake is successful if the MIC of the second access point is the same as the MIC of the dummy mobile station.

13. The method as claimed in claim 12, wherein the running step further comprises:
transmitting a fourth EAPOL-Key frame to the second access point.

14. The method as claimed in claim 12, wherein the running step further comprises:
determining that the 4-way handshake is not successful if the MIC of the second access point is not the same as the MIC of the dummy mobile station.

15. The method as claimed in claim 14, wherein the running step further comprises:
transmitting a disassociation frame from the dummy mobile station to the second access point.

16. A method for identifying a communicable status of an access point by means of another access point, comprising the steps of:
creating a dummy mobile station by a first access point;
authenticating a second access points by said dummy mobile station;
associating said dummy mobile station with said second access point; and
identifying a communicable status of said second access point based on a communication result of said dummy mobile station with said second access point.

17. The method as claimed in claim 16, further comprising the step of running a 4-way handshake with the second access point by the dummy mobile station to decide said communication result of said dummy mobile station with said second access point.
